(19) United States
(12) Patent Application Publication
(10) Pub. No.: US 2016/0125679 A1
(43) Pub. Date: May 5, 2016

(54) DEVICE, SYSTEM AND METHOD FOR SHARING VEHICLES

(71) Applicant: PVP TECHNOLOGIES CANADA INC., Montreal (CA)

(72) Inventor: Stephane SAVOURE, Kirkland (CA)

(73) Assignee: PVP TECHNOLOGIES CANADA INC.

(21) Appl. No.: 14/953,084

(22) Filed: Nov. 27, 2015

Related U.S. Application Data
(63) Continuation of application No. 14/002,469, filed on Aug. 30, 2013, now abandoned.

(30) Foreign Application Priority Data
Mar. 2, 2011 (FR) 1151685

(51) Int. Cl. G07C 9/00; E05B 81/90; E05B 85/00; E05B 81/78

(52) U.S. Cl. CPC G07C 9/00309; E05B 81/78; E05B 81/90; E05B 85/00; E05B 2047/0071

(57) ABSTRACT

A device for authorizing use of a vehicle, that comprises a cable for connection to an accreditation device of the vehicle, a memory for saving identification parameters of a key for enabling the vehicle and a detector for detecting a presence of a user. The device is configured to identify whether the detected user is an authorized user and, if so, to communicate via the cable with the accreditation device to authorize use of the key to enable the vehicle.

The present invention relates to a security device provided to secure the use of a vehicle shared by several users or a rental vehicle, in particular to ensure that the vehicle is indeed used by the anticipated user.

In this context of vehicle sharing or rental in particular, it is practical to leave an ignition key inside the vehicle, generally in the glove box. Thus, there is no longer any direct exchange of keys with the owner, which is restrictive. However, without a suitable security device or method, the vehicle becomes an easy target for thieves.

Devices of the electronic cutout switch type are known that are used in these cases. However, they all have at least two major drawbacks:
The installation of the housing acting as a cutout switch requires acting on the electrical cabling of the vehicle, which complicates installation of the device and may cause cancellation of the manufacturer warranty.
Most modern vehicles are equipped with an improved antitheft system working with a device for detecting the proximity of the key of the vehicle. Thus, the vehicle can only start if a valid key is in fact in or near the vehicle. Once a key, provided for sharing the vehicle, is located in the vehicle, a device of the cutout switch type offers a lower level of protection than the vehicle's original protection (manufacturer protection). This can cause problems in terms of the insurance policy.

The invention aims to propose a reinforced protection device making it possible to provide a vehicle to several users, an ignition key being left positioned in the vehicle, while ensuring, when a person starts the vehicle, that that person is indeed an authorized user.

Recent vehicles are equipped with smart keys, each containing an active or passive electronic chip that makes the key unique. In each vehicle, there is an onboard computer, often called the ECU (Engine Control Unit), in which an identifier is stored for each key authorized to start the vehicle. Thus, only a key whereof the identifier has been stored in the vehicle is capable of deactivating the engine immobilizer, and therefore allowing the vehicle to be driven.

Tools in particular exist making it possible to program a new key, for example when the keys are lost. As a general rule, only an approved agent can program a new key by connecting a dedicated tool on as CAN software bus accessible on an OBD (On Board Diagnostics, for example OBD-II type) port of the vehicle.

To achieve this aim and according to a first of its subject-matters, the invention proposes a device for authorizing the use of a vehicle, caracterized in that it comprises means for connecting to other means specific to the vehicle to accredit ignition keys, preferably via a CAN software bus, preferably accessible via an OBD port; memory means for saving identification parameters of a shared key; means for identifying the presence of an authorized user; and means for authorizing said user to use the shared key.

The means for authorizing the use of the key may comprise means for activating/deactivating the key, the identification parameters of the key being stored beforehand in the accreditation device. Alternatively, the means for authorizing use of the key may comprise means for recording the identification parameters of the key in the accreditation device when the use of the shared key is authorized and erasing the identification parameters of the key in the accreditation device when the use of the shared key is prohibited.

The means for detecting the presence of a user may comprise RFID antenna means.

The device may further comprise means for determining the position of the vehicle and means for transmitting a position to a remote server. The device may also comprise means for receiving availability and/or reservation information from a remote server. This device may further comprise means for sending an order to open the door to the vehicle.

According to a second subject-matter of the invention, a system according to the invention for sharing at least one vehicle is characterized in that each vehicle comprises a sharing device according to the invention and at least one remote server for exchanging sharing information, in particular on the position and/or availability and/or reservation, with a remote station and/or with the sharing device. Such a system advantageously comprises a recognition device specific to each user.

According to a third subject-matter of the invention, a method for authorizing the use of a shared vehicle, according to the invention, is characterized in that it comprises providing a device according to the invention and connecting it with the means specific to the vehicle to accredit ignition keys, preferably via a CAN software bus, preferably accessible via an OBD port, and steps for authorizing the use of the shared key by an authorized user and prohibiting the use of said key by another user.

The steps for authorizing the use of the key may comprise a step for recording the identification parameters of the key beforehand in the accreditation means, and a step for then activating said key, and the steps for prohibiting the use of said key may comprise a step for deactivating the key without erasing the identification parameters of the key previously stored in the accreditation means. Alternatively, the steps for authorizing the use of the key may comprise a step for recording the identification parameters of the key in the accreditation means, and the steps for prohibiting the use of said key may comprise a step for erasing the identification parameters of the key previously stored in the accreditation means.

Furthermore, a method for authorizing the use for a shared vehicle according to the invention may be characterized in that it comprises the use of a sharing system provided to assume a state for a “proprietary” use and a state for shared use, in which the proprietary use is free of any monitoring by said sharing system. Thus, the owner may use the vehicle as an ordinary vehicle not equipped for sharing, without the times, durations and locations of use being recorded or sent to the central server. For example, the position of the vehicle may only be recorded when the owner defines a period of availability.

In this document, “key” refers to any device provided to start the vehicle, whether that device assumes a traditional key form provided to be inserted into an orifice of the lock type, or, as is increasingly often the case, a card inserted into a slit. Traditional keys generally include a remote opening command for the doors, by pressing a button; cards generally have a contactless door opening function, of the capacitive type.

Several embodiments of the invention will be described below, as non-limiting examples, in reference to the appended drawings, in which:

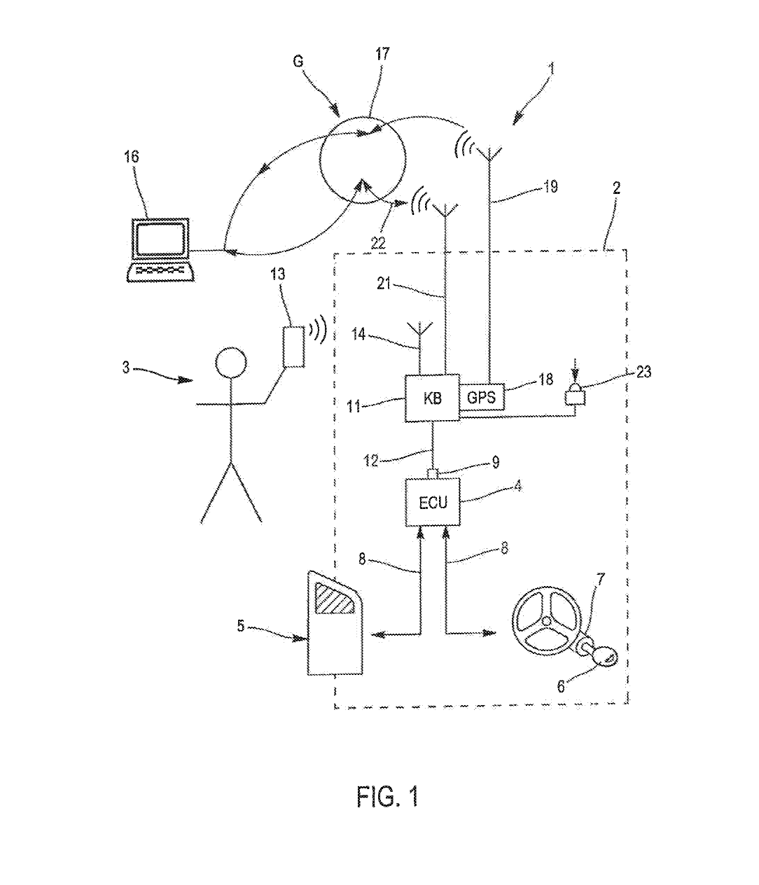

FIG. 1 illustrates a system implementing the invention; and

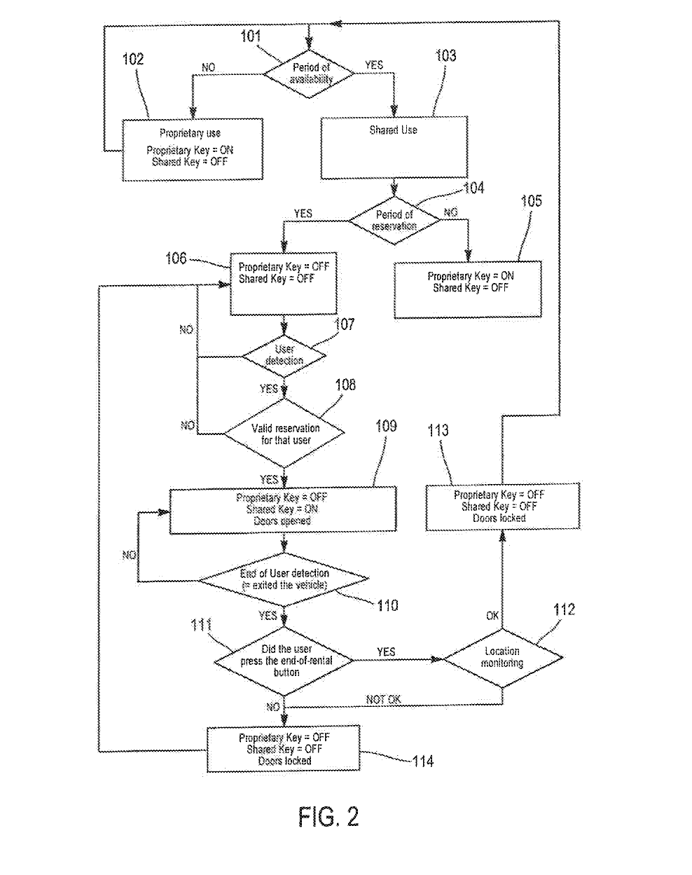

FIG. 2 is a flowchart illustrating one possible operation for the system of FIG. 1.

FIG. 1 is a diagrammatic illustration of a system 1 making it possible to implement a sharing service for a motor vehicle 2 between several users 3 of the sharing service. The motor vehicle 2 is depicted in FIG. 1 by a rectangle in broken lines. The sharing service is managed by a manager G.

The motor vehicle 2 in particular comprises a control unit 4 of the engine control unit (ECU) type. The control unit 4 is originally mounted on the vehicle 2, and makes it possible to control various pieces of equipment of the vehicle, in particular opening of the doors 5. Specific data buses 8 make it possible to connect the control unit 4 to each of these pieces of equipment. It also authorizes the startup of the vehicle 2 when a suitable ignition key is inserted into the starter device 7, or when the driver presses a start button. The identifiers of the keys (generally two) authorized to open and start the vehicle are stored in the control unit.

The control unit further comprises a computer port 9—for example of the type known by the abbreviation OBD-II (On Board Diagnostic, version II)—which in particular allows a technician to connect to the control unit 4 so as to run operating diagnostics on the vehicle 2. It is also through these means that a technician can also record a new key, for example to replace a lost key; the lost key may also be deprogrammed, so that it can no longer be used, in particular by an ill-intentioned person having stolen the key for that purpose.

The motor vehicle further comprises a sharing unit 11 (KB), dedicated to the sharing function of the invention; in other words, it is essentially using this unit that several users can share the vehicle in complete safety. In the described example, this unit is specific and is not originally mounted on the vehicle. The sharing unit 11 is connected to the port 9 by a bus 12.

People who wish to use such a vehicle, set for sharing by its owner, whether the owner is a natural person or legal entity, are recorded with the manager G. The manager U provides each of the users of the system 1 with recognition means 13, 14 allowing them to be recognized as a user by the system 1. In the illustrated example, the recognition means in particular comprise an RFID card 13, provided to each user 3, and an RFID antenna 14 equipping the sharing unit 11.

In the illustrated example, for a recognized user 3 to be authorized to use the vehicle 2, the vehicle must be available and the user must have reserved it.

A remote terminal 16 may be used to provide and/or reserve the vehicle 2. This remote station may be a stationary station, as illustrated in FIG. 1, or a mobile terminal, for example a mobile telephone.

The manager G comprises a computer server 17 that manages the provisions, reservations and position of the vehicle 2.

The position of the vehicle is calculated using a global positioning device 18, for example of the GPS (Global Positioning System) type. The position is then sent to the server using wireless telephony means 19, for example of the GSM type. Thus, the server may be informed of the exact position of each vehicle it manages; this information may be used to inform a user looking for a vehicle to borrow in a given area, and to inform a reserving party of the exact location of the vehicle; this information is also used to inform the owner of the position of the vehicle when the latter wishes to regain possession thereof.

Preferably, the information relative to the position of the vehicle is not sent to the server, or collected by the server 17, when the vehicle is unavailable or in use by a reserving party, except to inform the owner of the position of the vehicle if the latter has not already regained possession thereof. Thus, the confidentiality of travel, whether of the reserving party or the owner of the vehicle, particularly if the owner is a natural person, is preserved.

The sharing unit 11 comprises wireless telephony means 21 to communicate with the server 17. Thus, using a two-way transmission 22, the sharing unit may in particular be informed that the vehicle equipped therewith is available, or that the user 3 present is indeed the reserving party.

The system 1 further comprises a release button 23 mounted in the vehicle connected to the sharing unit 11; when the user wishes to end the reservation, and release the vehicle, the user need only press on the button 23.

In the example illustrated in FIG. 2, the owner of the vehicle is assumed to be a natural person, privately using the vehicle, outside availability windows. These availability windows are indicated by the user to the manager of the sharing service. The users 3 of the sharing service can therefore use the vehicle during those availability windows.

FIG. 2 uses a flow chart to illustrate the operation of a sharing unit 11 that can be used in a system 1 as previously described in reference to FIG. 1.

In its initial arrangement 101, the sharing unit 11 is in a standby position in which it verities whether a period of availability is in progress. As long as the unit has not been informed of the availability of the vehicle, a proprietary use 102 is maintained. Under “proprietary” usage conditions, the use of the shared key is not authorized, and that of the proprietary key is kept authorized. No monitoring of the vehicle is done; in particular the position of the vehicle is not read by the system. Only the owner's key makes it possible to start the vehicle. The opening of the doors occurs only with the manufacturer's original device. In this state 102, the sharing unit is not used to detect the presence of the owner, or that of another user.

When the unit KB is informed of a period of availability, the “shared usage” function 103 is implemented. In this position, the unit verities 104 whether a reservation period has begun and the sharing unit monitors the use of the vehicle. If no reservation is in progress, proprietary use 105 is maintained, and only the use of the proprietary key is authorized. The owner retains priority over the use of the vehicle and may use it in an emergency situation. If the user in fact uses the vehicle, the sharing unit 11 detects that use by the owner and informs the remote server 17 thereof. Operations may then be activated by the server 17, in particular relative to keeping the vehicle available or with respect to future reservations.

If, in the “shared use” position 103, a reservation period has begun, the use of two keys, proprietary and shared, is no longer authorized, while waiting for the reserving user. Thus, the unit 11 places itself in a standby position 106 during which it verifies 107 the presence or absence of the user, and if a user is present, it verifies 108 whether that user has a valid reservation.

When a user having a valid reservation is detected, the system enters a configuration 109 in which the use of the shared key is authorized, and the use of the proprietary key is prohibited; the opening of the vehicle doors is activated and the user can use the vehicle with the shared key.

In the usage configuration 109, the sharing unit monitors 110 the presence of the user in the vehicle. If the reserving user leaves the vehicle, the unit verifies whether the release button 23 has been pressed. If not, a securing operation 114 is activated: the use of the shared key is prohibited, the prohibition against the use of the proprietary key is maintained, and the doors are locked. The unit 11 returns to the standby position 106, awaiting the return of the same user.

If, on the contrary, the user leaves the vehicle and presses on the release button, the system 1 performs monitoring operations 112, in particular for monitoring the location of the vehicle. If the result of the monitoring operations 112 is negative, in particular if the vehicle is not parked in a planned location, the security operations 114 are activated: the use of the shared key is prohibited, the prohibition against the use of the proprietary key is maintained, and the doors are locked. The unit 11 returns to the standby position 106, awaiting the return of the same user.

If the result of the monitoring 112 is positive, security operations 113 are activated: the use of the shared key is prohibited, the prohibition against the use of the proprietary key is maintained, and the doors are locked. The unit 11 returns to the initial standby position 101, in which the unit verifies whether a period of availability is in progress.

Two methods for authorizing the use of the shared key, or for prohibiting the use thereof, may be used, and are mutually exclusive, depending on the operating mode chosen for the sharing unit 11 (KB).

According to a first method, called activation method, the identifier of the key is recorded in the control unit 4, and is maintained therein. The key 6 staying identified by the vehicle, the sharing unit sends a usage authorization, or usage prohibition, for the shared key 6.

According to the second method, called programming method, the identifier of the key is only recorded in the control unit 4 upon activation of the key, as a new key would be. Upon deactivation, the identifier is erased from the memory of the control unit, as a lost or stolen key would be. In this second method, the identifier of the shared key is therefore stored in the sharing unit, which sends it to the monitoring unit in due time.

Of course, the invention is not limited to the preferred embodiments described above.

Thus, it may be provided that a user of the sharing service does not reserve the vehicle beforehand. It may be provided, when the user is recognized, that there is a procedure allowing the user to use the vehicle, once the vehicle is available.

The wireless telephony means used by the sharing unit may be the same as the wireless telephony means used by the positioning device. This is the case when the positioning device is an integral part of the sharing unit; the antenna or modem means may be shared. On the contrary, if the positioning system of the vehicle 2 is part of its original equipment, the sharing unit and the positioning device may use independent telephony means, which are specific to them.

When the owner defines a period of availability, before that period of availability begins, the possibility may be provided for the owner to inform the server of the address at which the vehicle will be available. Thus, a first user may reserve the vehicle in advance, without it being necessary to wait for the beginning of the availability period to know the coordinates of the vehicle.

In the description provided above, it is clearly show that the proposed invention consists of using the software interface initially designed to program the keys of the vehicle, in the context of sharing one or more vehicles, so as to protect it or them from theft.

In the illustrated application, the sharing unit is connected by a cable to an existing port of the ECU of the vehicle. All of the information necessary to open the doors and for antitheft commands go through that cable. The installation therefore does not require any particular cabling, any welding, or any modification to the arrangements and original functions of the vehicle. The installation of the sharing unit according to the invention therefore does not require any particular skills and may be done directly by the owner of the vehicle. It may therefore be described as “plug and play”.

As a result, no modification being made to the cabling or the original functions of the vehicle, therefore guaranteeing at least the same level of theft protection, the use of a unit according to the invention does not pose any problems regarding the manufacturer warranty or an insurance policy.

The sharing unit operates as a sophisticated switch, which in particular activates and deactivates the shared key, while remaining completely transparent for the user.

A sharing unit according to the invention and a sharing system according to the invention are therefore particularly advantageous.

1. A device for authorizing use of a vehicle, comprising: a cable for connection to an accreditation device of the vehicle; a memory for saving identification parameters of a key for enabling the vehicle; a detector for detecting a presence of a user; the device being configured to identify whether the detected user is an authorized user and, if so, to communicate via the cable with the accreditation device to authorize use of the key to enable the vehicle.

2. The device according to claim 1, wherein to authorize use of the key, the device is further configured for communicating with the accreditation device to activate the key, the identification parameters of the key being stored beforehand in the accreditation device.

3. The device according to claim 1, the device being further configured for recording the identification parameters of the key in the accreditation device when the use of the key is authorized and erasing the identification parameters of the key in the accreditation device when the use of the key is prohibited.

4. The device according to claim 1, wherein the detector characterized in that the means for detecting the presence of a user may comprises an RFID antenna.

5. The device according to claim 1, further comprising a position device for determining a position of the vehicle and a transmitter for transmitting the determined position of the vehicle to a remote server.

6. The device according to claim 1, further comprising a two-way transmitter for receiving at least one of availability information and reservation information from a remote server.

7. The device according to claim 1, further configured for sending an order to open a door of the vehicle when the detected user is identified as an authorized user.

8. The device according to claim 1, wherein the key is a shared key.

9. The device according to claim 1, wherein the key is a not a proprietary key.

10. The device according to claim 1, the device being further configured to communicate via the cable with the accreditation device to prohibit use of the key by another user.

11. The device according to claim 5, wherein the position device is configured to refrain from sending the determined position information to the remote server while the vehicle is unavailable or is in use by the user.

12. A method for authorizing use of a vehicle, comprising:
detecting by a sharing unit within the vehicle a presence of a user during a reservation period for the vehicle;
verifying whether the user has a valid reservation to use the vehicle;
in case the user is verified to have a valid reservation to use the vehicle, communicating with a control unit of the vehicle to authorize use of a shared key to start the vehicle.

13. The method defined in claim 12, further comprising:
in response to detecting that use of the vehicle by the user has ended, communicating with the control unit of the vehicle to authorize use of a proprietary key to start the vehicle and to prohibit use of the shared key to start the vehicle.

14. The method defined in claim 13, wherein when communicating with the control unit of the vehicle to authorize use of the shared key to start the vehicle, use of the proprietary key to start the vehicle is prohibited.

15. The method according to claim 14, further comprising recording the identification parameters of the proprietary key and the shared key beforehand in the accreditation device, wherein to authorize use of either key, the method comprises activating said key without erasing the identification parameters of the other key previously stored in the accreditation device, and wherein to prohibit use of either key, the method comprises deactivating said key without erasing the identification parameters of the other key previously stored in the accreditation device.

16. The method according to claim 14, wherein to authorize use of either the proprietary key or the shared key, the method comprises recording the identification parameters of said key in the accreditation device, and wherein to prohibit use of either the proprietary key or the shared key the method comprises erasing the identification parameters of said key previously stored in the accreditation device.

17. A method for authorizing use of a vehicle, comprising:
communicating with a control unit of the vehicle to authorize at least one key to start the vehicle;
verifying whether a period of availability of the vehicle is in progress;
in case a period of availability of the vehicle is in progress, verifying whether a reservation period is in progress, and, in case a reservation period is in progress, verifying presence or absence of a user and, in case the user's presence is verified, verifying whether the user has a valid reservation, and in case the user is verified to have a valid reservation, communicating with the control unit of the vehicle to authorize at least one previously unauthorized key to start the vehicle and to prohibit at least one previously authorized key from starting the vehicle.

18. A system for sharing at least one vehicle, comprising:
a server configured to store locations of the at least one vehicle and manage availability of the at least one vehicle; and
a remote terminal configured for communicating with the server to reserve a particular vehicle for a user during a reservation period;
wherein the server is further configured to indicate to the remote terminal a location of the particular vehicle and to communicate towards a sharing device in the particular vehicle information to allow the sharing device to authorize use of the vehicle when presence of the user is detected during the reservation period.

19. The system according to claim 18, further comprising a recognition device specific to each user.

20. The system according to claim 19, wherein the remote terminal comprises a mobile telephone device.

21. The system according to claim 19, wherein the recognition device comprises an RFID card.
